(19) United States
(12) Patent Application Publication
(10) Pub. No.: US 2024/0290122 A1
(43) Pub. Date: Aug. 29, 2024

(54) SYSTEM AND METHOD FOR PROCESSING DOCUMENTS FOR ENHANCED SEARCH

(71) Applicant: Innoplexus AG, Eschborn (DE)

(72) Inventors: Oliver Pfante, Frankfurt am Main (DE); Akhil Nasser, Trivandrum (IN)

(73) Assignee: Innoplexus AG, Eschborn (DE)

(21) Appl. No.: 18/175,077

(22) Filed: Feb. 27, 2023

(51) Int. Cl. G06V 30/412; G06V 30/18; G06V 30/414

(52) U.S. Cl. CPC G06V 30/412; G06V 30/18181; G06V 30/414

(57) ABSTRACT

A method for processing documents for enhanced search includes identifying a set of bounding boxes in the document. The method further includes defining one or more pairs of bounding boxes in the document. Each pair of bounding boxes is defined by a binary relation. The method further includes constructing a directed acyclic graph (DAG) from the one or more pairs of bounding boxes. The method further includes determining a topological sorting of each bounding box in the document based on the DAG. The topological sorting defines an adjacency relationship between the bounding boxes in the document. The method further includes extracting key-value pairs from the document based on the adjacency relationship between the bounding boxes in the document. The method further includes storing the key-value pairs in a key-value pair database.

### FIELD OF TECHNOLOGY

The present disclosure relates generally to searching technology, and more specifically, to a system and a method for processing documents for enhanced search.

### BACKGROUND

In document analysis, information retrieval from documents is a challenging problem that requires a machine to understand not only text content of the documents but also its layout, such as relevant headers, keys, and contents in the documents. The information retrieval from documents is even more difficult in case of non-digitized documents. The document analysis is focused on reliable digitization of the documents prior to analysis, which preserves the information present in the original image. One specific aspect of the document analysis is extraction of key-value pairs, which requires teaching the machine about the adjacency of text. However, this task becomes tricky for machines due to the difficulty in determining a reading order of the text and the lack of a unique sorting of points in a two-dimensional plane.

Conventionally, the key-value pairs in the documents may be extracted using rule-based approaches and AI-driven approaches. Rule-based approaches rely on plain or fuzzy string matches and often introduce cumbersome rule-based implementations of an adjacency notion. The rule-based approaches may use plain or fuzzy string matches to identify relevant keys and extract their corresponding values. However, such approaches are often cumbersome to implement and rely on an optical character recognition (OCR) operation correctly sorting the text. In other words, the implementation of the rules is complex and takes a lot of effort to set up and maintain. On the other hand, AI-driven approaches utilize machine learning techniques to understand the layout and structure of the document, but such approaches may have a set of limitations and may be computationally expensive.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a system and a method for processing one or more documents for enhanced search. The present disclosure seeks to provide a solution to the existing problem of information retrieval from documents in terms of key-value pairs. The information retrieval from the documents may be a challenging problem, especially when dealing with non-digitized documents. An aim of the present disclosure is to provide a solution that overcomes at least partially the problems encountered in prior art and provide an improved system and method for processing documents for enhanced search in a way such that each key-value pair may be extracted from the document and then extracted information may be searched and accessed through a search portal.

In one aspect, the present disclosure provides a method for processing one or more documents for enhanced search, the method comprising:
identifying, by a processor, a set of bounding boxes in a document of the one or more documents, wherein the document comprises hand-written content or digital content;
defining, by the processor, one or more pairs of bounding boxes in the document, wherein each pair of bounding boxes is defined by a binary relation; constructing, by the processor, a directed acyclic graph (DAG) from the one or more pairs of bounding boxes;
determining, by the processor, a topological sorting of each bounding box in the document based on the DAG, the topological sorting defining an adjacency relationship between the set of bounding boxes in the document;
extracting, by the processor, key-value pairs from the document based on the adjacency relationship between the set of bounding boxes in the document; and
storing, by the processor, the extracted key-value pairs in a key-value pair database.

The method of the present disclosure may utilize a binary relation between bounding boxes in a certain angular direction, and the DAG constructed by the one or more pairs of bounding boxes, to achieve a topological sorting of the bounding boxes which in turn allows for the extraction of the key-value pairs in any direction with increased accuracy and effectiveness. The DAG constructed by the one or more pairs of bounding boxes may provide a structure for organizing and traversing the bounding boxes in a specific order to extract the key-value pairs and may be used to define the adjacency relationship between the set of bounding boxes. The adjacency relationship may be used to extract the key-value pairs from the document and to link them together in a meaningful way. By utilizing the DAG constructed from the one or more pairs of bounding boxes, the key-value pairs may be extracted. Specifically, traversing the DAG may help in extraction of the key-value pairs. Further, search operation for specific information in the document may be enabled by searching through the extracted key-value pairs, rather than searching through the document in a linear fashion.

The method may extract the key-value pairs from the documents in any angular direction. The angular directions defining the binary relations between the bounding boxes may allow the determination of adjacency relationships with mathematical rigor in any angular directions. This may allow for the extraction of the key-value pairs in any direction, unlike conventional methods. This may further allow for greater flexibility in extracting information from the documents and used to extract the key-value pairs from different types of the documents without requiring specific adjustments or modifications to the method.

In another aspect, the present disclosure provides a system for processing one or more documents for enhanced search, the system comprising:
a memory configured to store the one or more documents; and
a processor communicatively coupled with the memory, wherein the processor is configured to:
   identify a set of bounding boxes in a document of the one or more documents;
   define one or more pairs of bounding boxes in the document, wherein each pair of bounding boxes is defined by a binary relation;
   construct a directed acyclic graph (DAG) from the one or more pairs of bounding boxes;
   determine a topological sorting of each bounding box in the document based on the DAG, the topological sorting defining an adjacency relationship between the set of bounding boxes in the document; and
   extract key-value pairs from the document based on the adjacency relationship between the set of bounding boxes in the document; store the extracted key-value pairs in a key-value pair database.

The system achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for processing one or more documents for enhanced search, in accordance with an embodiment of the present disclosure;

FIG. 2 is a block diagram of another system for processing the one or more documents for enhanced search, in accordance with an embodiment of the present disclosure;

FIG. 3 is a schematic diagram of an exemplary document with bounding boxes, in accordance with an embodiment of the present disclosure;

FIG. 4 is a schematic diagram depicting a binary relation between a pair of bounding boxes;

FIG. 5 is a diagram depicting an exemplary directed acyclic graph constructed based on one or more pairs of bounding boxes, in accordance with an embodiment of the present disclosure;

FIG. 6 is a flowchart for processing the one or more documents for enhanced search, in accordance with an embodiment of the present disclosure; and

FIG. 7 is a flowchart of a method for processing the one or more documents for enhanced search, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

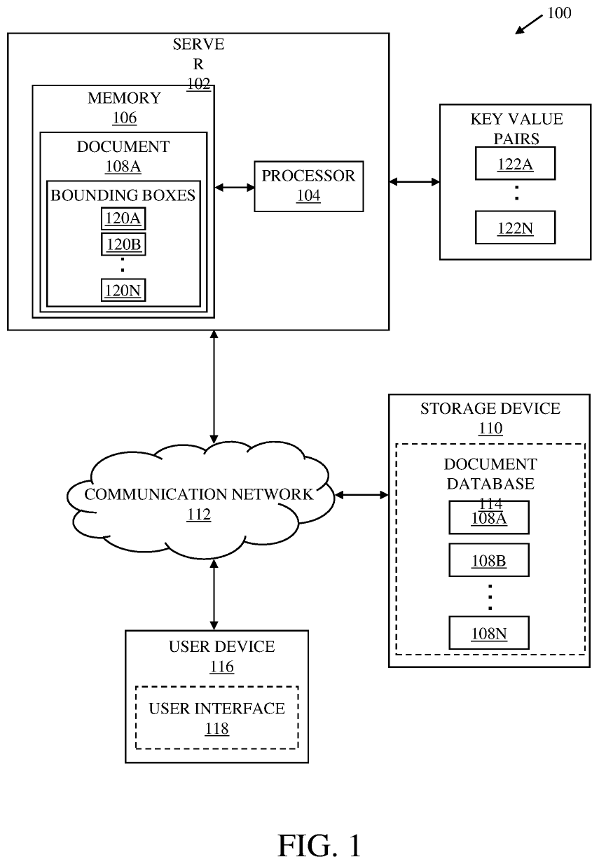

FIG. 1 is a block diagram of a system for processing one or more documents for enhanced search, in accordance with an embodiment of the present disclosure. With reference to FIG. 1, there is shown a block diagram of a system 100. The system 100 includes a server 102, a processor 104, and a memory 106. The processor 104 is communicatively coupled with the memory 106. The system 100 may be used to process one or more documents 108A to 108N.

In an implementation, the processor 104 and the memory 106 may be implemented on a same server, such as the server 102. In some implementations, the system 100 further includes a storage device 110 communicatively coupled to the server 102 via a communication network 112. The storage device 110 includes a document database 114 of the one or more documents 108A to 108N. In some implementations, the one or more documents 108A to 108N may be retrieved from the storage device 110 by the memory 106, as per requirement. In some implementations, the document database 114 may be stored in the same server, such as the server 102. In some other implementations, the document database 114 may be stored outside the server 102, as shown in FIG. 1. The server 102 may be communicatively coupled to a plurality of user devices, such as a user device 116, via the communication network 112. The user device 116 includes a user interface 118.

The present disclosure provides the system 100 that processes the one or more documents 108A to 108N for enhanced search, where the system 100 extracts key-value pairs from the documents 108A to 108N. The documents 108A to 108N may include, but not limited to, medical records, such as patient charts and lab reports, legal documents, such as contracts and court transcripts, business documents, such as invoices and purchase orders, financial documents, such as bank statements and tax returns, technical manuals and instructional documents. In some implementations, the one or more documents 108A to 108N to be stored in the memory 106 are in a non-digital format or a hand-written format. In some other implementations, the one or more documents 108A to 108N to be stored in the memory 106 are in a digital format. In an implementation, the document 108A includes hand-written content or digital content. The key-value pair refers to a set of two linked data items, where one item is the key, which is used to identify the item, and the other item is the value, which is the data associated with the key.

The server 102 includes suitable logic, circuitry, interfaces, and code that may be configured to communicate with the user device 116 via the communication network 112. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. The memory 106 is configured to store the one or more documents 108A to 108N. Furthermore, a single memory may encompass and, in a scenario, and the system 100 is distributed, the processor 104, the memory 106 and/or storage capability may be distributed as well. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The storage device 110 may be any storage device that stores data and applications without any limitation thereto. In an implementation, the storage device 110 may be a cloud storage, or an array of storage devices.

The communication network 112 includes a medium (e.g., a communication channel) through which the user device 116 communicates with the server 102. The communication network 112 may be a wired or wireless communication network. Examples of the communication network 112 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The user device 116 refers to an electronic computing device operated by a user. The user device 116 may be configured to obtain a user input of one or more words in a search portal or a search engine rendered over the user interface 118 and communicate the user input to the server 102. The server 102 may then be configured to retrieve the key-value pairs related to the one or more words. Examples of the user device 116 may include but not limited to a mobile device, a smartphone, a desktop computer, a laptop computer, a Chromebook, a tablet computer, a robotic device, or other user devices.

It should be understood by one of ordinary skills in the art that the operations of the system 100 are explained by using the document 108A. However, the operation of the system 100 is equally applicable for the one or more documents 108A to 108N.

In operation, the processor 104 is configured to identify a set of bounding boxes 120A to 120N in the document 108A of the one or more documents 108A to 108N. In an implementation, the processor 104 is further configured to identify the one or more bounding boxes 120A to 120N in the document 108A using an optical character recognition (OCR) operation. In order to identify the one or more bounding boxes 120A to 120N in the document 108A using the OCR operation, the processor 104 is further configured to analyze a layout of the document 108A, and locate each bounding box. In some examples, relative positions of the set of bounding boxes 120A to 120N may be determined by comparing x and y coordinates of the set of bounding boxes 120A to 120N on the document 108A, as well as the relative size of each bounding box. It should be noted that an upper left corner of the document 108A may be considered as the origin of x-y plane for comparing the x and y coordinates of the set of bounding boxes 120A to 120N on the document 108A. Once the bounding boxes 120A to 120N are identified, the processor 104 may extract the text contained within each bounding box and converts the text into a string format. In other words, the OCR operation is used to locate text in the document 108A, and the processor 104 extracts the text from the set of bounding boxes 120A to 120N and converts it into a machine-readable format. For example, consider an invoice document that contains several bounding boxes with text inside them such as invoice number, date, customer name, and amount due. The processor 104 may use the OCR operation to identify the set of bounding boxes in the invoice document, extract the text inside each bounding box, and return the output in the form of strings.

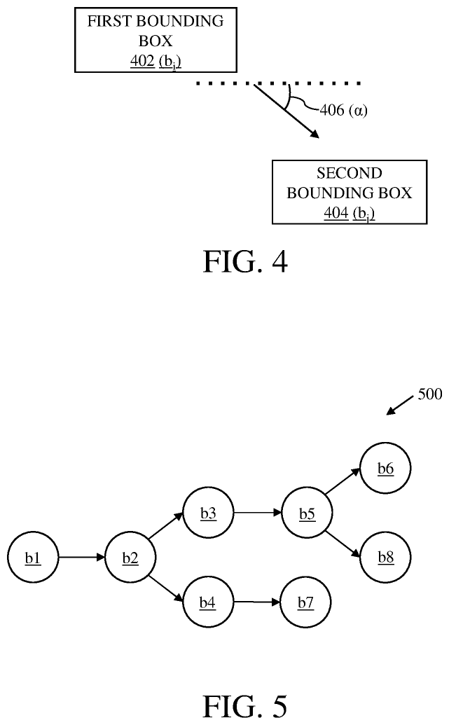

The processor 104 is further configured to define one or more pairs of bounding boxes 120A to 120N in the document 108A based on binary relations. Each pair of bounding boxes is defined by a binary relation. The binary relation refers to a relationship between two bounding boxes in the document 108A. In an implementation, the binary relation is based on a distance between each pair of bounding boxes when one of the bounding boxes from the pair of bounding boxes is translated in the one or more predetermined directions. In other words, the binary relation is based on the one or more predefined directions, and is defined by intersection between each pair of bounding boxes when translated in the respective direction. In some implementations, each of the one or more predetermined directions is a predetermined angular direction taken from a set of predetermined angular directions. The set of predetermined angular directions is defined for determining the binary relation between the set of bounding boxes 120A to 120N in the document 108A. Each predetermined angular direction of the set of predetermined angular directions is ranging from 0 degree to 360 degrees. In order to define the binary relation between each pair of bounding boxes, each pair of bounding boxes may not have an overlap. Further, the binary relation is defined such that if one of the bounding boxes from the pair of bounding boxes is translated in the predetermined direction, then the pair of bounding boxes has an intersection with one another, thereby implying that the pair of bounding boxes are considered “adjacent” to each other in the predetermined direction. Furthermore, in another implementation, the binary relation is defined such that if one of the bounding boxes from the pair of bounding boxes may be translated in a first predetermined direction or a second predetermined direction, then the pair of bounding boxes has an intersection with one another, thereby implying the pair of bounding boxes are considered “adjacent” to each other in the first predetermined direction or the second predetermined direction. Similarly, the binary relation may be defined such that one of the bounding boxes from the pair of bounding boxes may be translated in any number of directions. In some examples, the binary relation between each pair of bounding boxes is defined by a parameter α, where α is an angular direction in the range of [0, 2π]. In addition, the binary relation is denoted as ≤_{α}. In an example, if a binary relation between a bounding box bᵢ and a bounding box bⱼ is defined by an angular direction α, then the binary relation is denoted by equation: bᵢ≤_{α}bⱼ (as shown in FIG. 4), which represents that the bounding box bᵢ overlaps with the bounding box bⱼ when the bounding box bᵢ is translated at the angular direction α. In another example, if a binary relation between the bounding box bᵢ and the bounding box bⱼ is defined by a first angular direction α or a second angular direction β, then the binary relation is denoted by equation: bi≤_{α,β}bj, which represents that the bounding box bᵢ overlaps with the bounding box bⱼ when the bounding box bᵢ is translated at the first angular direction α or the second angular direction β.

The processor 104 is further configured to construct a directed acyclic graph (DAG) from the one or more pairs of bounding boxes. The DAG refers to a graph that represents the relationship between the set of bounding boxes 120A to 120N in terms of their ordering with respect to the predetermined direction. The DAG constructed from the one or more pairs of bounding boxes in turn allows for the extraction of the key-value pairs 122A to 122N in any predetermined direction with increased accuracy and effectiveness. In order to construct the DAG from the one or more pairs of bounding boxes, the processor 104 is further configured to construct the DAG having each bounding box of the one or more pairs of bounding boxes as nodes and a directed edge between the respective nodes if the corresponding pair of bounding boxes are related by the binary relation. In other words, if the one or more pairs of bounding boxes are related by the binary relation, the DAG includes the nodes and the directed edge between the respective nodes. The nodes represent the bounding boxes and the directed edge between the respective nodes represents a one-way binary relationship between the corresponding pair of bounding boxes in the predetermined direction, as indicated by an arrow. In an example, if there are three bounding boxes in a sample document, then a constructed DAG may include the three bounding boxes as nodes and directed edges between the respective nodes for one or more pairs of bounding boxes formed from the three bounding boxes that are related by the binary relations. The construction of an exemplary DAG will be explained in detail with reference to FIG. 5.

The processor 104 is further configured to determine a topological sorting of each bounding box in the document 108A based on the DAG. The topological sorting defines an adjacency relationship between the set of bounding boxes 120A to 120N in the document 108A. The topological sorting of the DAG refers to a partial ordering of the nodes (representing each bounding box) in the DAG such that, for every directed edge in the DAG, the starting node of the directed edge comes before the ending node of the directed edge in the partial ordering. For example, if there is a directed edge from a node n₁ to a node n₂, then the node n₁ may appear before the node n₂ in the partial ordering. The partial ordering is induced by the topological sorting of the DAG. The adjacency relationship refers to an order in which the set of bounding boxes 120A to 120N are adjacent to one another in the DAG. The adjacency relationship may be used to determine the closest neighboring bounding box to a given bousing box in the predetermined direction. By topologically sorting the DAG, the processor 104 may further determine the adjacency relationship between the set of bounding boxes 120A to 120N in the document 108A. In other words, the topological sorting may determine which bounding boxes 120A to 120N are closest to each other in the predetermined direction. The adjacency relationship between the set of bounding boxes 120A to 120N may be used for extracting key-value pairs 122A to 122N from the document 108A.

The processor 104 is further configured to extract the key-value pairs 122A to 122N from the document 108A based on the adjacency relationship between the set of bounding boxes 120A to 120N in the document 108A. The key-value pairs 122A to 122N refers to the extracted text from within each bounding box and the corresponding bounding box or boxes with which the extracted text is associated. In an implementation, in order to extract the key-value pairs 122A to 122N from the document 108A based on the adjacency relationship between the set of bounding boxes 120A to 120N, the processor 104 is further configured to identify each bounding box containing a key string from the set of bounding boxes 120A to 120N for labelling each bounding box containing the key string as a key bounding box. The processor 104 is further configured to select, based on the adjacency relationship between the set of bounding boxes 120A to 120N, strings in bounding boxes adjacent to each key bounding box as values for the corresponding key-value pair. For example, the processor 104 may identify a bounding box containing the text “Patient Name” and label it as a key bounding box. Based on the adjacency relationship defined between the set of bounding boxes, the processor 104 may then identify the bounding box adjacent to the “Patient Name” bounding box and extract the text within that bounding box as the value for the “Patient Name” key-value pair. Similarly, the processor 104 may extract “Patient Age” as a key and a bounding box containing age adjacent to the “Patient Age” bounding box as value.

The DAG constructed by the one or more pairs of bounding boxes may provide a structure for organizing and traversing the bounding boxes 120A to 120N in a specific order to extract the key-value pairs 122A to 122N. and may be used to define the adjacency relationship between the set of bounding boxes 120A to 120N. The adjacency relationship may be used to extract the key-value pairs 122A to 122N from the document 108A and to link them together in a meaningful way.

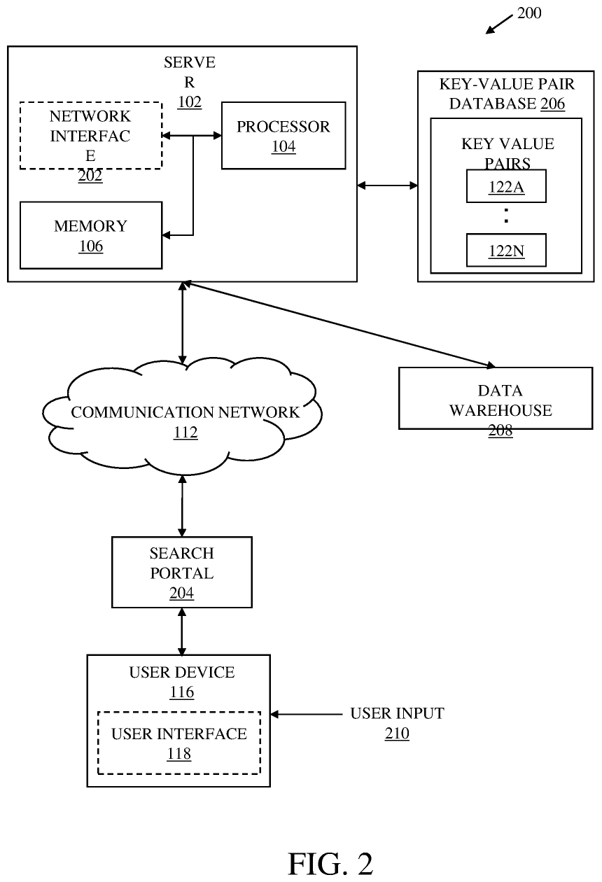

FIG. 2 is a block diagram of another system for processing one or more documents for enhanced search, in accordance with an embodiment of the present disclosure. FIG. 2 is described in conjunction with elements from FIG. 1. With reference to FIG. 2, there is shown a block diagram of a system 200 that includes the server 102, the processor 104 and the memory 106. The system 200 may be used to search and access the extracted information i.e., the extracted key-value pairs of the one or more documents 108A to 108N.

It should be understood by one of ordinary skills in the art that the system 200 and operation of the system 200 are explained using the document 108A. However, the operation of the system 100 is equally applicable for the one or more documents 108A to 108N.

The server 102 includes the processor 104 and the memory 106. The server 102 may further include a network interface 202. The network interface 202 is configured to communicate with the processor 104 and the memory 106. The system 200 further includes a search portal 204 communicatively connected to the server 102 and accessible by the user device 116, via the user interface 118 rendered on the user device 116. The system 200 further includes a key-value pair database (KVPD) 206 communicatively connected to the server 102. In an implementation, the KVPD 206 may be stored in the server 102. In some other implementations, the KVPD 206 may be stored outside the server 102, as shown in the system 200. The KVPD 206 may include the extracted key-value pairs 122A to 122N. The system 200 further includes a data warehouse 208 communicatively connected to the server 102. In an implementation, the data warehouse 208 may be stored in the server 102. In some other implementations, the data warehouse 208 may be stored outside the server 102, as shown in the system 200. The data warehouse 208 includes extracted key-value pairs from the one or more documents 108A to 108N.

The network interface 202 refers to a communication interface to enable communication of the server 102 to any other external device, such as the user device 116. Examples of the network interface 202 include, but are not limited to, a network interface card, a transceiver, and the like.

The search portal 204 refers to a search platform to enable a user to carry out web searches. In some examples, the search portal 204 may be a hospital search platform, a company search platform, or any other type of search platform that allows users to search for and access information stored in the KVPD 206. The search portal 204 may be used to search for a specific information in the document 108A by using a key of the extracted key-value pairs 122A to 122N to quickly locate a corresponding value in the document 108A, thereby improving search and retrieval capability.

The KVPD 206 refers to a collection of the extracted key-value pairs 122A to 122N from the document 108A stored in the document database 114. The data warehouse 208 refers to a large, centralized repository of data that is used for data analysis and reporting. The data warehouses 208 are designed to support efficient querying and analysis of data, and are typically used to support business decision-making, data mining, and analytics.

In operations, the processor 104 is further configured to form the KVPD 206 based on the extracted key-value pairs 122A to 122N. In some examples, the processor 104 is further configured to integrate the extracted key-value pairs 122A to 122N with the search portal 204, such that a key of the extracted key-value pairs 122A to 122N and a corresponding value associated with the key are locatable in the document 108A during a search.

The processor 104 is further configured to form the data warehouse 208 of the key-value pairs in the one or more documents 108A to 108N for the search portal 204 based on performing the topological sorting of each bounding box in the one or more documents 108A to 108N. The processor 104 is further configured to receive a user input 210 of one or more words in the search portal 204. The processor 104 is further configured to retrieve key-value pairs related to the one or more words based on the topological sorting defining the adjacency relationship between the set of bounding boxes 120A to 120N in the document 108A.

By utilizing the DAG constructed from the one or more pairs of bounding boxes, the key-value pairs 122A to 122N may be extracted. Specifically, traversing the DAG may help in extraction of the key-value pairs 122A to 122N. Further, search operation for specific information in the document 108A may be enabled by searching through the extracted key-value pairs 122A to 122N, rather than searching through the document 108A in a linear fashion. Additionally, the DAG may be used to impose the partial ordering among the bounding boxes 120A to 120N of the text.

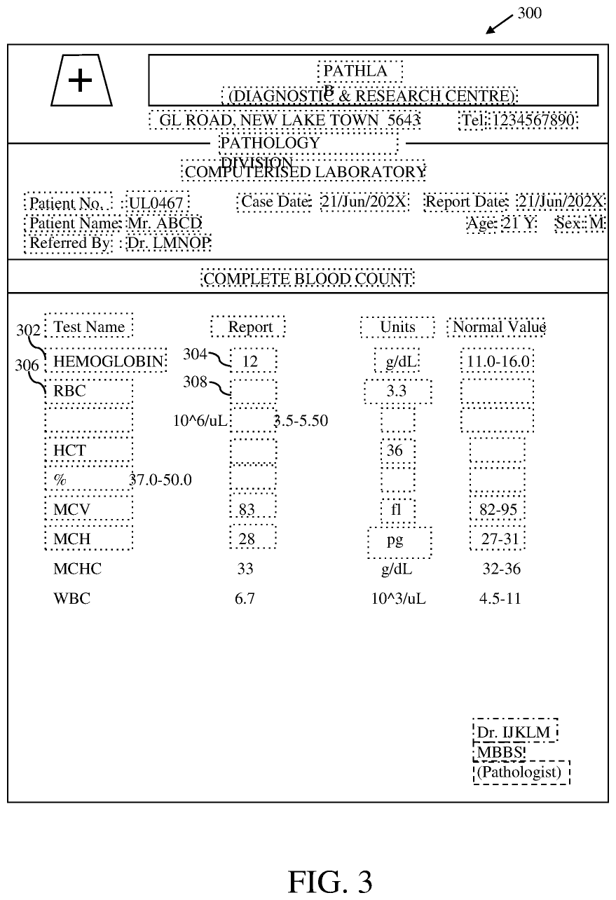

FIG. 3 depicts an exemplary document with bounding boxes, in accordance with an embodiment of the present disclosure. FIG. 3 is described in conjunction with elements from FIGS. 1 and 2. With reference to FIG. 3, there is shown an exemplary document 300 that includes one or more bounding boxes identified by the OCR operation. Specifically, the OCR operation analyzes the exemplary document 300 and detects regions that contain text, and then creates a bounding box around each region. The processor 104 (of FIG. 1) is configured to identify the bounding boxes by the OCR operation. In an implementation, the processor 104 may be configured to semantically label the bounding boxes in the exemplary document 300 using various techniques such as natural language processing, machine learning techniques, or rule-based methods. It should be noted that only bounding boxes 302, 304, 306, 308 are shown in FIG. 3 for illustrative purposes.

After the identification of the bounding boxes 302, 304, 306, 308 in the exemplary document 300, the bounding boxes 302, 304, 306, 308 are paired with one another. The pairing of the bounding boxes 302, 304, 306, 308 may be done randomly. In some implementations, the pairing of the bounding boxes may be based on the distance between the bounding boxes 302, 304, 306, 308. In other words, closest bounding boxes may be paired with one another. For example, the bounding box 302 may be paired with either of the bounding boxes 304, 306, and the bounding box 306 may be paired with either of the bounding boxes 302, 308. Similarly, the bounding box 304 may be paired with either of the bounding boxes 302, 308, and the bounding box 308 may be paired with either of the bounding boxes 304, 306.

In order to determine a correct pair of bounding boxes in the exemplary document 300, the binary relation is defined for each pair of bounding boxes in the exemplary document 300, based on one or more predetermined directions. In other words, in order to extract key-value pairs correctly in the exemplary document 300, the binary relation is defined for each pair of bounding boxes in the exemplary document 300, based on the one or more predetermined direction. Further, the key and the values associated with the key may be used for extracting information. For example, the bounding box 302 having text “HEMOGLOBIN” is a key bounding box and the bounding box 304 has a value “12” associated with the key bounding box. In this example, the value “12” depicts the units of hemoglobin. Similarly, other information, such as patient name, patient number, patient age, and like, may be extracted from the exemplary document 300.

FIG. 4 is a schematic diagram depicting a binary relation between a pair of bounding boxes, in accordance with an embodiment of the present disclosure. With reference FIG. 4, there is shown a binary relation between a first bounding box 402 and a second bounding box 404.

In an implementation, the first and second bounding boxes 402, 404 may be identified in a document (similar to the one or more documents 108A to 108N). The first and second bounding boxes 402, 404 may also be referred as the first bounding box bᵢ and the second bounding box bⱼ, respectively. Further, the first and second bounding boxes 402, 404 are located at an angular direction 406 that is represented by a parameter α. Moreover, the first and second bounding boxes 402, 404 are located at a distance from one another. The binary relation between the first bounding box bᵢ and the second bounding box bⱼ may be defined by bᵢ≤bⱼ, that is, bᵢ is an α-precessor of bⱼ. To define the binary relation, the first and second bounding boxes and may not have an overlap, that is, bᵢ∩bⱼ=∅. Further, if the first bounding box bᵢ is translated in the direction α then there is a distance such that the bounding box bᵢ has an intersection with the bounding box bⱼ, i.e., bᵢ∩bⱼ≠∅.

FIG. 5 is a diagram depicting an exemplary directed acyclic graph (DAG) constructed based on one or more pairs of bounding boxes, in accordance with an embodiment of the present disclosure. With reference FIG. 5, there is shown a DAG 500. The DAG 500 includes 8 nodes and 7 directed edges between the respective nodes. The nodes of the DAG represent a set of bounding boxes b1 to b8. Further, pairs of bounding boxes b1-b2, b2-b3, b2-b4, b4-b7, b3-b5, b5-b6, and b5-b8 are related by the binary relations and have directed edges therebetween. Although only 8 bounding boxes are shown in FIG. 5, a DAG constructed based on the one or more pairs of bounding boxes may include each pair of bounding boxes in the document which are related by the binary relations.

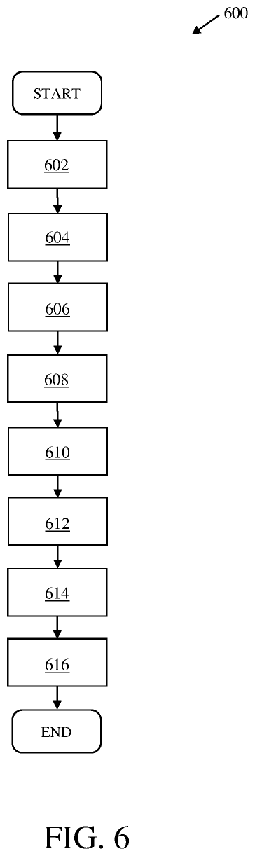

FIG. 6 is a flowchart for processing the one or more documents for enhanced search, in accordance with an embodiment of the present disclosure. FIG. 6 is described in conjunction with elements from FIGS. 1 and 2. With reference to FIG. 6, there is shown a flowchart 600 that includes a series of operations from 602-to-616. The processor 104 (of FIG. 1) is configured to execute the flowchart 600.

At operation 602, the processor 104 is configured to identify the set of bounding boxes 120A to 120N in the document 108A of the one or more documents 108A to 108N along with the text within the set of bounding boxes 120A to 120N by running the one or more documents 108A to 108N through the OCR operation. Thereafter, at operation 604, the processor 104 is further configured to decide the one or more pairs of the bounding boxes 120A to 120N. After that, at operation 606, the processor 104 is further configured to input key text, the predetermined direction with respect to the key text, and the number of bounding boxes that are under consideration of being a value of the key text. Furthermore, at operation 608, the processor 104 is further configured to search through the set of bounding boxes 120A to 120N to identify the bounding box containing the key text provided at operation 606. After that, at operation 610, the processor 104 is further configured to determine topology sorting of the set of bounding boxes 120A to 120N as per respective predetermined direction specified at the operation 606. Furthermore, at operation 612, the processor 104 is further configured to obtain the bounding boxes containing the values of the key bounding box using the adjacency relationship defined by the topological sorting. After that, at operation 614, the processor 104 is further configured to add the key-value pairs, which represent information extracted from the set of bounding boxes 120A to 120N in the document 108A, to the KVPD 206. Furthermore, at operation 616, the processor 104 is further configured to repeat the operations 602 to 614 until each key-value pair in the document 108A is extracted and stored in the KVPD 206.

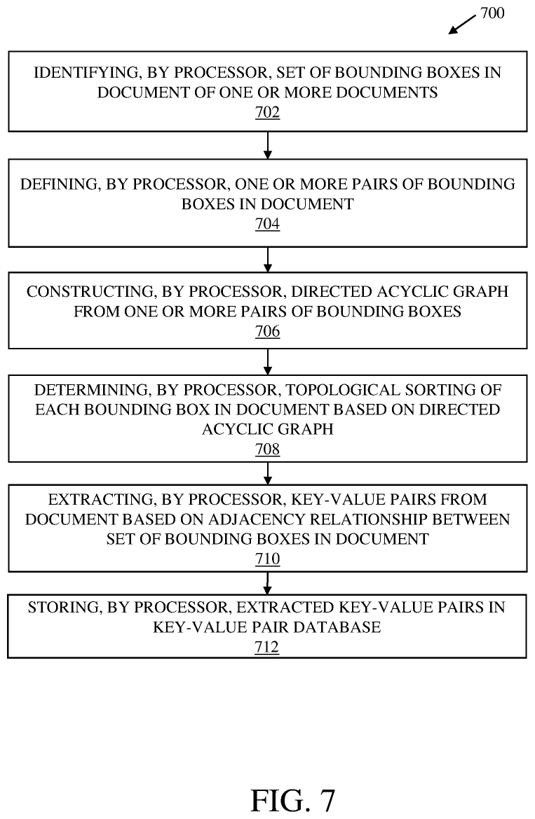

FIG. 7 is a flowchart of a method for processing one or more documents for enhanced search, in accordance with an embodiment of the present disclosure. FIG. 7 is explained in conjunction with elements from FIGS. 1 and 2. With reference FIG. 7, there is shown a flowchart of a method 700. The method 700 is executed at the server 102 (of FIG. 1). The method 700 may include steps 702 to 714.

At step 702, the method 700 includes identifying, by the processor 104, the set of bounding boxes 120A to 120N in the document 108A of the one or more documents 108A to 108N. The document 108A includes hand-written content or digital content. The identifying of the one or more bounding boxes 120A to 120N in the document 108A includes using the OCR operation to identify the set of bounding boxes 120A to 120N in the document 108A and extract the text inside each bounding box and return the output in the form of strings.

At step 704, the method 700 further includes defining, by the processor 104, the one or more pairs of bounding boxes 120A to 120N in the document 108A. Each pair of bounding boxes is defined by a binary relation. The binary relation is based on the distance between each pair of bounding boxes when one of the bounding boxes from the pair of bounding boxes is translated in the at least one predetermined direction. Each of the at least one predetermined direction is a predetermined angular direction taken from a set of predetermined angular directions. The set of predetermined angular directions is defined for determining the binary relation between the set of bounding boxes 120A to 120N in the document 108A. Each predetermined angular direction of the set of predetermined angular directions is ranging from 0 degree to 360 degrees.

At step 706, the method 700 further includes constructing, by the processor 104, the DAG (similar to the DAG 500 of FIG. 5) from the one or more pairs of bounding boxes. The constructing of the DAG from the one or more pairs of bounding boxes includes constructing the DAG having each bounding box of the pair of bounding boxes as the nodes and the directed edge between the respective nodes if the corresponding pair of bounding boxes are related by the binary relation. The DAG constructed by the one or more pairs of bounding boxes may provide a structure for organizing and traversing the extracted key-value pairs 122A to 122N in a specific order.

At step 708, the method 700 further includes determining, by the processor 104, the topological sorting of each bounding box in the document 108A based on the DAG. The topological sorting defines the adjacency relationship between the set of bounding boxes 120A to 120N in the document 108A.

At step 710, the method 700 further includes extracting, by the processor 104, the key-value pairs 122A to 122N from the document 108A based on the adjacency relationship between the set of bounding boxes 120A to 120N in the document 108A. The extracting of the key-value pairs 122A to 122N from the document 108A based on the adjacency relationship between the set of bounding boxes 120A to 120N includes identifying each bounding box containing the key string from the set of bounding boxes 120A to 120N to label each bounding box containing the key string as the key bounding box. The extracting of the key-value pairs 122A to 122N from the document 108A based on the adjacency relationship between the set of bounding boxes 120A to 120N further includes selecting, based on the adjacency relationship between the set of bounding boxes 120A to 120N, strings in the bounding boxes adjacent to each key bounding box as the values for the corresponding key-value pair.

At step 712, the method 700 further includes storing, by the processor 104, the extracted key-value pairs 122A to 122N in the KVPD 206. Storing the extracted key-value pairs 122A to 122N in the KVPD 206 may facilitate storage, organization, and retrieval of the extracted key-value pairs 122A to 122N in an efficient and organized manner.

In some examples, the method 700 further includes integrating, by the processor 104, the extracted key-value pairs 122A to 122N with the search portal 204, such that a key of the extracted key-value pairs 122A to 122N and a corresponding value associated with the key are locatable in the document 108A during the search. This allows the search portal 204 to search for a specific information in the document 108A by using the key of the extracted key-value pairs 122A to 122N to quickly locate a corresponding value in the document 108A.

In accordance with an embodiment, the method 700 further includes forming, by the processor 104, the data warehouse 208 of the key-value pairs in the one or more documents 108A to 108N for the search portal 204 based on performing the topological sorting of each bounding box in the one or more documents 108A to 108N.

In accordance with an embodiment, the method 700 further includes receiving, by the processor 104, the user input 210 of the one or more words in the search portal 204. The method 700 further includes retrieving, by the processor 104, the key-value pairs related to the one or more words based on the topological sorting defining the adjacency relationship between the set of bounding boxes 120A to 120N in the document 108A.

By utilizing the DAG constructed from the one or more pairs of bounding boxes, the method 700 may extract the key-value pairs 122A to 122N. Specifically, traversing the DAG may help in extraction of the key-value pairs 122A to 122N. Further, the method 700 may enable search operation for specific information in the document 108A by searching through the extracted key-value pairs 122A to 122N, rather than searching through the document 108A in a linear fashion.

The method 700 may utilize the binary relation between the one or more pairs of bounding boxes in a certain angular direction, and the DAG constructed by the one or more pairs of bounding boxes, to achieve the topological sorting of the set of bounding boxes 120A to 120N, thereby allowing for the extraction of the key-value pairs 122A to 122N in any direction. In other words, the method 700 may extract the key-value pairs from the documents 108A to 108N in any linear or angular direction. The linear or angular directions defining the binary relations between the pairs of bounding boxes may allow the determination of adjacency relationships with mathematical rigor in the linear or angular directions. This may allow for the extraction of the key-value pairs in any direction, unlike conventional methods. This may further allow for greater flexibility in extracting information from the documents 108A to 108N and used to extract the key-value pairs from different types of documents without requiring specific adjustments or modifications to the method 700 or the systems 100, 200. Thus, the method 700 and the system 100, 200 significantly improve the search portal 204 capability and effectiveness in retrieving accurate and relevant information and discarding non-relevant information.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A method for processing one or more documents for enhanced search, the method comprising:
identifying, by a processor, a set of bounding boxes in a document of the one or more documents, wherein the document comprises hand-written content or digital content;
defining, by the processor, one or more pairs of bounding boxes in the document, wherein each pair of bounding boxes is defined by a binary relation;
constructing, by the processor, a directed acyclic graph (DAG) from the one or more pairs of bounding boxes;
determining, by the processor, a topological sorting of each bounding box in the document based on the DAG, the topological sorting defining an adjacency relationship between the set of bounding boxes in the document;
extracting, by the processor, key-value pairs from the document based on the adjacency relationship between the set of bounding boxes in the document; and
storing, by the processor, the extracted key-value pairs in a key-value pair database.

2. The method according to claim 1, wherein the identifying of the one or more bounding boxes in the document comprises using an optical character recognition (OCR) operation to identify the set of bounding boxes in the document and extract text inside each bounding box and return the output in the form of strings.

3. The method according to claim 1, wherein the binary relation is based on a distance between each pair of bounding boxes when one of the bounding boxes from the pair of bounding boxes is translated in at least one predetermined direction.

4. The method according to claim 3, wherein each of the at least one predetermined direction is a predetermined angular direction taken from a set of predetermined angular directions.

5. The method according to claim 4, wherein the set of predetermined angular directions is defined for determining the binary relation between the set of bounding boxes in the document.

6. The method according to claim 4, wherein each predetermined angular direction of the set of predetermined angular directions is ranging from 0 degree to 360 degrees.

7. The method according to claim 1, wherein the construction of the DAG from the one or more pairs of bounding boxes comprises constructing the DAG having each bounding box of the pair of bounding boxes as nodes and a directed edge between the respective nodes if the corresponding pair of bounding boxes are related by the binary relation.

8. The method according to claim 1, wherein the extracting of the key-value pairs from the document based on the adjacency relationship between the set of bounding boxes comprises:
identifying each bounding box containing a key string from the set of bounding boxes to label each bounding box containing the key string as a key bounding box, and
selecting, based on the adjacency relationship between the set of bounding boxes, strings in bounding boxes adjacent to each key bounding box as values for the corresponding key-value pair.

9. The method according to claim 1, further comprising forming, by the processor, a data warehouse of key-value pairs in the one or more documents for the search portal based on performing the topological sorting of each bounding box in the one or more documents.

10. The method according to claim 1, further comprising:
receiving, by the processor, a user input of one or more words in the search portal; and
retrieving, by the processor, key-value pairs related to the one or more words based on the topological sorting defining the adjacency relationship between the set of bounding boxes in the document.

11. A system for processing one or more documents for enhanced search, the system comprising:
a memory configured to store the one or more documents; and
a processor communicatively coupled with the memory, wherein the processor is configured to:
identify a set of bounding boxes in a document of the one or more documents;
define one or more pairs of bounding boxes in the document, wherein
each pair of bounding boxes is defined by a binary relation;
construct a directed acyclic graph (DAG) from the one or more pairs of bounding boxes;
determine a topological sorting of each bounding box in the document based on the DAG, the topological sorting defining an adjacency relationship between the set of bounding boxes in the document;
extract key-value pairs from the document based on the adjacency relationship between the set of bounding boxes in the document; and
store the extracted key-value pairs in a key-value pair database.

12. The system according to claim 11, wherein the processor is further configured to identify the set of bounding boxes in the document using an optical character recognition (OCR) operation, and wherein in order to identify the one or more bounding boxes in the document using the OCR operation, the processor is further configured to:
analyze a layout of the document; and
locate each bounding box.

13. The system according to claim 11, wherein the binary relation is based on a distance between each pair of bounding boxes when one of the bounding boxes from the pair of bounding boxes is translated in at least one predetermined direction.

14. The system according to claim 13, wherein the at least one predetermined direction is a predetermined angular direction taken from a set of predetermined angular directions.

15. The system according to claim 11, wherein the one or more documents to be stored in the memory are in a non-digital format or a hand-written format.

16. The system according to claim 11, wherein the one or more documents to be stored in the memory are in a digital format.

17. The system according to claim 11, wherein, in order to construct the DAG from the one or more pairs of bounding boxes, the processor is further configured to construct the DAG having each bounding box of the one or more pairs of bounding boxes as nodes and a directed edge between the respective nodes if the corresponding pair of bounding boxes are related by the binary relation.

18. The system according to claim 11, wherein, in order to extract the key-value pairs from the document based on the adjacency relationship between the set of bounding boxes, the processor is further configured to:
identify each bounding box containing a key string from the set of bounding boxes for labelling each bounding box containing the key string as a key bounding box, and
select, based on the adjacency relationship between the set of bounding boxes, strings in bounding boxes adjacent to each key bounding box as values for the corresponding key-value pair.

19. The system according to claim 11, wherein the processor is further configured to form a data warehouse of key-value pairs in the one or more documents for the search portal based on performing the topological sorting of each bounding box in the one or more documents.

20. The system according to claim 11, wherein the processor is further configured to:
receive a user input of one or more words in the search portal; and
retrieve key-value pairs related to the one or more words based on the topological sorting defining the adjacency relationship between the set of bounding boxes in the document.
